(19) United States
(12) Patent Application Publication
(10) Pub. No.: US 2026/0298129 A1
(43) Pub. Date: Oct. 1, 2026

(54) EFFICIENT HEAT DISSIPATION DEVICE FOR ENGINE

(71) Applicant: Chongqing Hudson New Energy Co., Ltd., Chongqing (CN)

(72) Inventors: Sheng Li, Chongqing (CN); Hui Yang, Chongqing (CN)

(21) Appl. No.: 19/341,323

(22) Filed: Sep. 26, 2025

(30) Foreign Application Priority Data
Sep. 27, 2024 (CN) 202422376697.4

(51) Int. Cl. F01P 5/04; F02B 67/06

(52) U.S. Cl. CPC F01P 5/04; F02B 67/06

(57) ABSTRACT

An efficient heat dissipation device for an engine includes a frame and an axial flow fan. The frame is connected to the engine. The axial flow fan is rotatably arranged on the frame and is driven by the engine crankshaft. In this embodiment, the axial flow fan supplies air along the fan axis. The size of the axial flow fan is large enough so that the air distribution area can cover the entire engine. The efficiency of heat dissipation is improved as the various parts of the entire engine can be air-cooled from one side at the same time. In addition, compared with the combined heat dissipation solution of a centrifugal fan and an air guide cover, the direct air supply of the axial flow fan directly blows the engine without kinetic energy loss, further improving the heat dissipation efficiency.

### TECHNICAL FIELD

The invention relates to the technical field of engines, in particular to an efficient heat dissipation device of an engine.

### BACKGROUND

The engine heat dissipation generally uses a centrifugal fan with a wind scooper. Specifically, a centrifugal fan is arranged on the side of the engine and is connected with the outer end of a crankshaft of the engine. The wind scooper is covered outside the centrifugal fan. In addition, the centrifugal fan is driven to rotate through the crankshaft of the engine, and wind blown out by the centrifugal fan is guided to the engine by the wind scooper, such that the purpose of engine heat dissipation is achieved. The efficiency of heat dissipation directly affects the engine power, and how to improve the efficiency of heat dissipation remains a key challenge.

### SUMMARY

In view of the deficiencies of the prior art, the present invention provides an efficient heat dissipation for engine that at least improves one or more of the above-identified and other problems of the prior art.

The invention provides a high-efficiency heat dissipation device for an engine, which comprises:

A frame connected with the engine, and

The axial flow fan is rotationally arranged on the rack and is driven by an engine crankshaft;

And the air distribution area of the axial flow fan covers the whole engine.

Preferably, the method further comprises:

A first belt pulley rotatably disposed on the frame and connected with a crankshaft of the engine, and

A second belt pulley is rotatably arranged on the frame, is coaxially connected with the axial flow fan and is in transmission connection with the first belt pulley through a belt.

Preferably, the diameter of the second pulley is greater than the diameter of the first pulley.

Preferably, the projection of the second pulley is located above the engine crankshaft.

Preferably, two third-pulleys are also included. The two third belt pulleys are positioned between the first belt pulley and the second belt pulley, and the connecting line of the first belt pulley and the second belt pulley is intersected with the connecting line of the two third belt pulleys. The first belt pulley, the second belt pulley, and the two third belt pulleys are in transmission connection through the belt.

The belt pulley comprises a frame, a first belt pulley, a second belt pulley, and a ring-shaped supporting piece.

Compared with the prior art, the invention has a multitude of benefits. In the technology of the invention, the axial flow fan supplies air along the axial direction of the fan. The size of the axial flow fan is large enough, and the air distribution area of the axial flow fan can cover the whole engine, such that all parts of the whole engine can be subjected to air cooling and heat dissipation from one side at the same time. As a result, the heat dissipation efficiency is improved.

### DRAWINGS

In order to more clearly illustrate the embodiments of the present invention or the technical solutions in the prior art, the drawings used in the description of the embodiments or the prior art will be briefly described below. Similar elements or portions are generally identified by similar reference numerals throughout the several figures. In the drawings, elements or portions thereof are not necessarily drawn to scale.

FIG. 1 is a perspective view of an engine high efficiency heat sink in accordance with an embodiment of the present invention;

FIG. 2 is a further perspective view of FIG. 1;

FIG. 3 is a perspective view of an engine efficient heat dissipating device according to an embodiment of the present invention;

FIG. 4 is a further perspective view of FIG. 3 (no axial fan).

### Reference Numerals

10. a frame;
20. an axial flow fan;
30. a first pulley;
40. a second pulley;
50. A third-pulley;
60. An annular support.

### DETAILED DESCRIPTION

Embodiments of the technical scheme of the present invention will be described in detail below with reference to the accompanying drawings. The following examples are only for more clearly illustrating the technical aspects of the present invention and thus are merely examples and are not intended to limit the scope of the present invention.

It is noted that unless otherwise indicated, technical or scientific terms used herein should be given the ordinary meaning as understood by one of ordinary skill in the art to which this invention belongs.

In the description of the present invention, it should be understood that the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate orientations or positional relationships based on the orientations or positional relationships shown in the drawings. These terms are merely for convenience in describing the present invention and simplifying the description and do not indicate or imply that the device or element being referred to must have a specific orientation or be configured and operated in a specific orientation. Therefore, these terms should not be construed as limiting the present invention.

Furthermore, the terms “first,” “second,” and the like, are used for descriptive purposes only and are not to be construed as indicating or implying a relative importance or implicitly indicating the number of technical features indicated. In the description of the present invention, the meaning of “plurality” is two or more unless specifically defined otherwise.

In the present invention, unless explicitly specified and limited otherwise, the terms “mounted,” “connected,” “secured,” and the like are to be construed broadly, and may be, for example, fixedly connected, detachably connected, or integrally formed, mechanically connected, electrically connected, directly connected, indirectly connected via an intervening medium, or in communication between two elements or in an interaction relationship between two elements. The specific meaning of the above terms in the present invention can be understood by those of ordinary skill in the art according to the specific circumstances.

In the present application, unless expressly stated or limited otherwise, a first element is “above” or “below” a second element may refer that the first and second elements in direct contact, or the first and second elements in indirect contact via an intervening medium. Moreover, a first element being “above,” “over” and “on” a second element may be a first element being directly above or obliquely above the second element, or simply indicating that the first element is level higher than the second element. The first element being “under”, “below” and “beneath” the second element may be the first element being directly under or obliquely below the second element, or simply indicating that the first element is less level than the second feature.

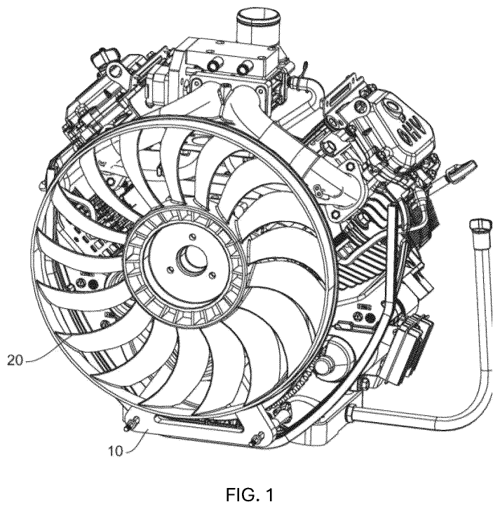

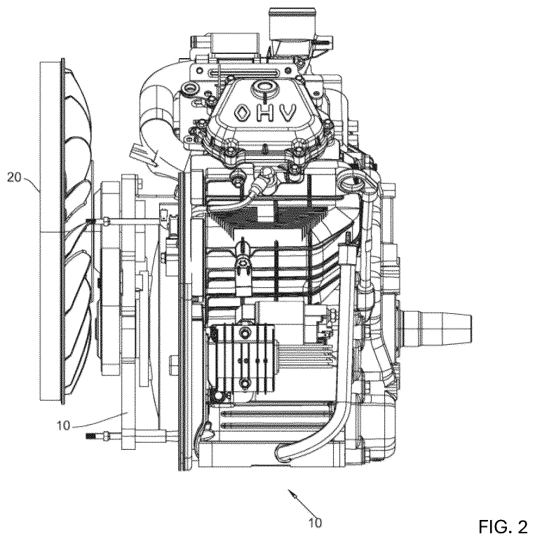

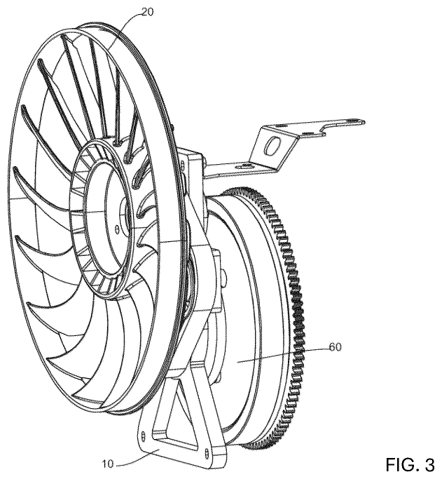

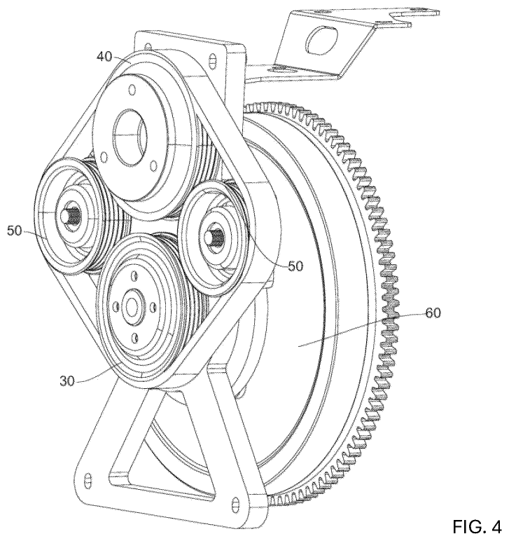

Referring to FIG. 1 to 4, the present embodiment provides an engine efficient heat dissipating device including a housing 10 and an axial flow fan 20.

The frame 10 is connected to an engine. The axial flow fan 20 is rotatably provided on the housing 10, and the axial flow fan 20 is driven by an engine crankshaft. The air distribution area of the axial flow fan 20 covers the entire engine.

In this embodiment, the axial flow fan 20 supplies air along the axial direction of the fan, and the axial flow fan 20 has a size large enough to cover the whole engine, such that all parts of the whole engine can be cooled and radiated by air from one side at the same time. As a result, the radiating efficiency is improved. In addition, compared with the combined heat radiation scheme of the centrifugal fan and the air guide cover, the axial flow fan 20 directly blows air to the engine, so that no kinetic energy is lost, and the heat radiation efficiency is further improved.

In one embodiment, the engine high efficiency heat sink further includes a first pulley 30 and a second pulley 40.

The first pulley 30 is rotatably provided on the frame 10, and the first pulley 30 is connected to a crankshaft of the engine. The second belt pulley 40 is rotatably provided on the housing 10, the second belt pulley 40 is coaxially connected with the axial flow fan 20, and the second belt pulley 40 is in driving connection with the first belt pulley 30 by a belt.

In this embodiment, the engine drives the axial fan 20 to rotate and can lose part of power, and the heat dissipation efficiency of the engine is good, such that the output power can be improved. The transmission ratio between the first pulley 30 and the second pulley 40 can be adjusted by selecting different sizes when the first pulley 30 and the second pulley 40 are installed, so that the value of the increase of the output power of the engine due to the improvement of the heat dissipation efficiency is larger than the power loss value of the engine driving the axial fan 20. Namely, the increase of the output power of the engine is realized.

In one embodiment, the diameter of the second pulley 40 is preferably greater than the diameter of the first pulley 30.

In this embodiment, the diameter of the second pulley 40 is larger than that of the first pulley 30, so that the rotation speed of the axial fan 20 is lower than that of the crankshaft of the engine. As a result, better heat dissipation efficiency and engine power improvement effect can be achieved.

In one embodiment, the projection of the second pulley 40 is located in the middle of the engine. Specifically, when a conventional centrifugal fan is connected to the crankshaft of an engine, the centrifugal fan is located on the side of the crankcase and is located at the lower portion of the engine. The second belt pulley 40 is disposed above the crankshaft of the engine and corresponds to the middle of the whole engine, i.e. the second belt pulley 40 is disposed above the first belt pulley 30. By this, the axial flow fan 20 moves up integrally, and the axial flow fan 20 can be of a larger size to obtain a larger air distribution area, thereby covering the whole engine.

In one embodiment, the engine high efficiency heat sink further includes two third-pulleys 50. Two third-pulleys 50 are located between the first pulley 30 and the second pulley 40. The connection line of the first pulley 30 and the second pulley 40 intersects with the connection line of the two third-pulleys 50, specifically, the connection line of the first pulley 30 and the second pulley 40 intersects with the connection line of the two third-pulleys 50 in a cross arrangement. The first pulley 30, the second pulley 40 and the two third-pulleys 50 are connected by a belt drive.

In the present embodiment, the two third-pulleys 50 together with the first pulley 30 and the second pulley 40 may be disposed such that the belt is stably transmitted during the movement, and the vibration is small, thereby stabilizing the rotational speed of the axial flow fan 20.

In one embodiment, the engine high efficiency heat sink further includes an annular support 60. The ring support 60 is fixedly connected with the frame 10. The surface of the annular support 60 facing the first pulley 30 is a conical surface, and the axis of the annular support 60 coincides with the axis of the first pulley 30.

In this embodiment, the first pulley 30 is opposite to the crankcase, and the heat dissipation requirement at the crankcase is low. The axial fan 20 is blown to the wind direction around the crankcase by the annular supporting member 60 for guiding the flow, so as to further improve the heat dissipation efficiency of the engine.

In the description of the present invention, numerous specific details are set forth. However, it is understood that embodiments of the invention may be practiced without these specific details. In some instances, well-known methods, structures and techniques have not been shown in detail in order not to obscure an understanding of this description.

It should be noted that the above embodiments are only used to illustrate the technical solution of the present invention, but not to limit the technical solution of the present invention, and although the detailed description of the present invention is given with reference to the above embodiments, it should be understood by those skilled in the art that the technical solution described in the above embodiments may be modified or some or all technical features may be equivalently replaced, and these modifications or substitutions do not make the essence of the corresponding technical solution deviate from the scope of the technical solution of the embodiments of the present invention, and all the modifications or substitutions are included in the scope of the claims and the specification of the present invention.

1. A high efficiency heat dissipation device for an engine, comprising:
a frame connected to the engine; and
an axial flow fan rotatably arranged on the frame and driven by an engine crankshaft, wherein the air distribution area of the axial flow fan covers the whole engine.

2. The high efficiency heat dissipation device as defined in claim 1, further comprising:
a first pulley rotatably mounted on the frame and connected to the crankshaft of the engine; and
the second pulley is rotatably arranged on the frame, wherein the second pulley is coaxially connected with the axial flow fan, and wherein the second pulley is in transmission connection with the first pulley through a belt.

3. The high efficiency heat dissipation device according to claim 2, wherein the diameter of the second pulley is larger than the diameter of the first pulley.

4. The high efficiency heat dissipation device as defined in claim 3, wherein the second pulley is positioned above the engine crankshaft.

5. The high efficiency heat dissipating device as set forth in any of claim 2 further comprising two third-pulleys, wherein the two of the third-pulleys are located between the first pulley and the second pulley, wherein a line connecting the first pulley and the second pulley intersects a line connecting the two third-pulleys, and wherein the first pulley, the second pulley and the two third-pulleys are drivingly connected by the belt.

6. The high efficiency heat dissipating device of claim 5, further comprising:
an annular support, wherein the annular support is fixedly connected to the frame;
wherein the surface of the annular supporting piece facing the first belt pulley is a conical surface; and
wherein the axis of the annular supporting piece coincides with the axis of the first belt pulley.

7. The high efficiency heat dissipating device as set forth in any of claim 3, further comprising two third-pulleys, wherein the two of the third-pulleys are located between the first pulley and the second pulley, wherein a line connecting the first pulley and the second pulley intersects a line connecting the two third-pulleys, and wherein the first pulley, the second pulley and the two third-pulleys are drivingly connected by the belt.

8. The high efficiency heat dissipating device of claim 7, further comprising:
an annular support, wherein the annular support is fixedly connected to the frame;
wherein the surface of the annular supporting piece facing the first belt pulley is a conical surface; and
wherein the axis of the annular supporting piece coincides with the axis of the first belt pulley.

9. The high efficiency heat dissipating device as set forth in any of claim 4 further comprising two third-pulleys, wherein the two of the third-pulleys are located between the first pulley and the second pulley, wherein a line connecting the first pulley and the second pulley intersects a line connecting the two third-pulleys, and wherein the first pulley, the second pulley and the two third-pulleys are drivingly connected by the belt.

10. The high efficiency heat dissipating device of claim 9, further comprising:
an annular support, wherein the annular support is fixedly connected to the frame;
wherein the surface of the annular supporting piece facing the first belt pulley is a conical surface; and
wherein the axis of the annular supporting piece coincides with the axis of the first belt pulley.
